(19) United States
(12) Patent Application Publication
(10) Pub. No.: US 2011/0218869 A1
(43) Pub. Date: Sep. 8, 2011

(54) GOODS SALE DATA PROCESSOR AND CONTROL METHOD THEREOF

(75) Inventor: Mitsuyuki Tamura, Shizuoka (JP)

(73) Assignee: TOSHIBA TEC KABUSHIKI KAISHA, Tokyo (JP)

(21) Appl. No.: 13/037,551

(22) Filed: Mar. 1, 2011

(30) Foreign Application Priority Data
Mar. 2, 2010 (JP) 2010-045644

(51) Int. Cl. G06Q 30/00

(52) U.S. Cl. 705/16

(57) ABSTRACT

A goods sale data processor performs a process of registering goods to be transacted. Reserved registering information to be reserved is stored. The reserved registering information to be reserved is updated and stored in a storage unit when the registering process is reserved, the registering process is being performed, and when the updated reserved registering information is notified from another goods sale data processor. The updated reserved registering information is notified to another goods sale data processor when the processor reserves the registering process. When the registering process is requested to restart, the selection of the reserved registering information used to restart the registering process out of the reserved registering information stored in the storage unit is received and the registering process is restarted using the selected reserved registering information.

### CROSS-REFERENCE TO RELATED APPLICATION

This application is based upon and claims the benefit of priority from the prior Japanese Patent Application No. 2010-45644, Mar. 2, 2010 the entire contents of which are incorporated herein by reference.

### FIELD

The present invention relates to a goods sale data processor and a control method thereof.

### BACKGROUND

A goods sale data processor (for example, POS (Point Of Sales) terminal) used to register goods to be transacted with clients is installed in convenience stores and the like. Such a goods sale data processor has a function of performing a sold goods registering process for a current customer in a normal operation and reserving the current transaction and then performing the sold goods registering process for a next customer when sales reservation occurs because a customer forgets the purchase of some goods or the like.

For example, Japanese Patent No. 3949792 discloses a POS system in which a POS terminal transmits sales reservation data to a POS master and the POS master temporarily stores the sales reservation data when reservation, and a POS terminal receives reservation response data from the POS master and performs an accounting operation when the reservation is released.

### DESCRIPTION OF THE DRAWINGS

FIG. 1 is a block diagram illustrating the configurations of a POS terminal control device and peripheral devices thereof according to an embodiment of the invention.

FIG. 2 is a block diagram illustrating the electrical configuration of the POS terminal control device according to the embodiment of the invention.

FIG. 3 is a block diagram illustrating the functional configuration of the POS terminal control device according to the embodiment of the invention.

FIG. 4 is a diagram illustrating an overall POS reserved sale registering information table stored in a data storage unit according to the embodiment of the invention.

FIG. 5 is a flow diagram illustrating the flow of a goods registering process including a reservation process.

FIG. 6 is a flow diagram illustrating the flow of a restarting process according to the embodiment of the invention.

FIG. 7 is a diagram illustrating an example of a registering picture according to the embodiment of the invention.

FIG. 8 is a diagram illustrating an example of the registering picture according to the embodiment of the invention.

FIG. 9 is a diagram illustrating an example of the registering picture according to the embodiment of the invention.

FIG. 10 is a diagram illustrating an example of the updated overall POS reserved sale registering information table according to the embodiment of the invention.

FIG. 11 is a diagram illustrating an example of a reservation sheet according to the embodiment of the invention.

FIG. 12 is a diagram illustrating an example of the registering picture according to the embodiment of the invention.

FIG. 13 is a diagram illustrating an example of the registering picture according to the embodiment of the invention.

FIG. 14 is a diagram illustrating an example of the registering picture according to the embodiment of the invention.

FIG. 15 is a diagram illustrating an example of the updated overall POS reserved sale registering information table according to the embodiment of the invention.

FIG. 16 is a diagram illustrating an example of the registering picture according to the embodiment of the invention.

FIG. 17 is a diagram illustrating an example of the registering picture according to the embodiment of the invention.

FIG. 18 is a diagram illustrating an example of the updated overall POS reserved sale registering information table according to the embodiment of the invention.

### DETAILED DESCRIPTION

The above-mentioned goods sales data processor has a problem in that it cannot reserve the sold goods registering process for two or more customers. As disclosed in Japanese Patent No. 3949792, when the POS master collectively manages the sales reservation data and a trouble such as disorder occurs in the POS master, there is a problem in that the accounting operation cannot be performed after the release of reservation.

The invention is made in consideration of the above-mentioned problems. A goal of the invention is to provide a goods sales data processor which can reserve a sold goods registering process for plural customers and which is resistant to a trouble such as disorder when reservation, and a control method thereof.

According to an aspect of the invention, there is provided a goods sale data processor includes: registering unit for performing a process of registering goods to be transacted; storage unit for storing reserved registering information to be reserved; reserved registering information updating unit for updating and storing the reserved registering information to be reserved in the storage unit when the registering process which is being performed by the registering unit is reserved and when the updated reserved registering information is notified from another goods sale data processor; reserved registering information notifying unit for notifying another goods sale data processor of the reserved registering information updated by the reserved registering information updating unit when the processor reserves the registering process; and restarting unit for receiving the selection of the reserved registering information used to restart the registering process out of the reserved registering information stored in the storage unit and restarting the registering process using the selected reserved registering information when the registering process is requested to restart.

Hereinafter, a goods sales data processing system according to an embodiment of the invention will be described with reference to the accompanying drawings. In this embodiment, the goods sales data processing system includes plural goods sales data processors and the goods sales data processors are applied to POS (Point Of Sale) terminals.

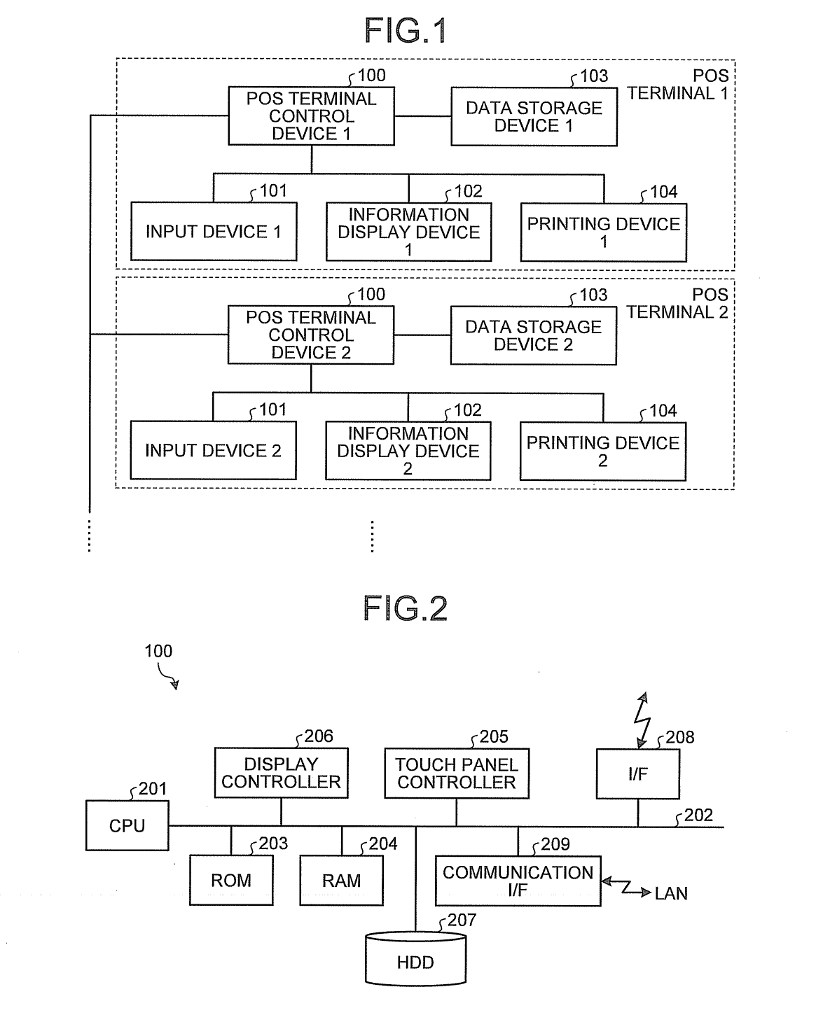

FIG. 1 is a block diagram illustrating the configurations of a POS terminal control device 100 and peripheral devices thereof according to the embodiment of the invention. As shown in FIG. 1, the POS terminal control device 100 according to this embodiment is connected to an input device 101 such as a keyboard, an information display device 102 in which a touch panel as an input device is stacked on a display plane of a display device such as an LCD (Liquid Crystal Display), a data storage device 103 as an auxiliary storage device storing a variety of information, such as an HDD (Hard Disk Drive), and a printing device 104 printing out a receipt or a reservation sheet to be described later. The POS terminal control device 100 and the peripheral devices thereof (101, 102, and 103) constitute a POS terminal. In this embodiment, the internal configurations of plural POS terminal control devices 100 and the peripheral devices (101, 102, and 103) are the same as each other.

FIG. 2 is a block diagram illustrating the electrical configuration of the POS terminal control device 100. In the POS terminal control device 100, as shown in FIG. 2, a CPU 201 collectively controlling the units thereof is connected to a ROM 203 storing in advance fixed information such as a starting control program and various setting information, and a RAM 204 into which post-starting control programs are loaded and which serves as a work area re-writably storing various information via a bus line 202. The CPU 201, the ROM 203, and the RAM 204 constitute a controller (controller 300 to be described later) controlling the POS terminal control device 100.

The CPU 201 is connected to a touch panel controller 205, a display controller 206, a built-in HDD 207 that can also be used as the data storage device 103, an interface 208, and a communication interface 209 via the bus line 202. The HDD 207 is connected to the bus line 202 via an interface not shown. The touch panel controller 205 introduces an input signal from the input device 101 and the information display device 102 (touch panel) into the CPU 201. The display controller 206 controls the driving of the information display device 102 (LCD) on the basis of image data and displays the image data on the information display device 102.

The interface 208 is an interface used to connect the printing device 104 or an image display device not shown to the CPU 201 and is formed of a USB or the like. The communication interface 209 is an interface allowing the CPU 201 to transmit and receive data to and from other devices via a LAN. An OS or computer programs such as applications controlling the POS terminal control device 100 and various files (which are referred to as control programs in this embodiment) are installed in the HDD 207. The control programs are loaded into the RAM 204 from the HDD 207 at the time of starting.

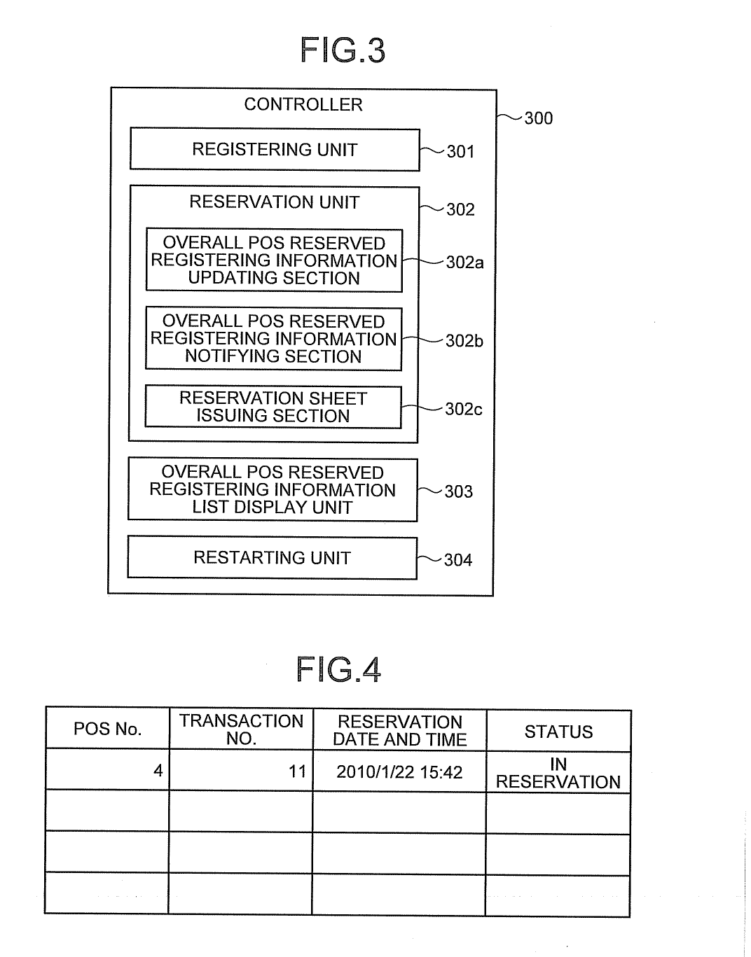

Subsequently, out of processes performed by the CPU 201 using the control programs installed in the HDD 207 of the POS terminal control device 100, characterized processes of the POS terminal control device 100 according to this embodiment will be described with reference to FIG. 3. FIG. 3 is a block diagram illustrating the functional configuration of the POS terminal control device 100 according to this embodiment.

The OS and the computer programs executed by the POS terminal control device 100 according to this embodiment may be recorded in a computer-readable recording medium such as a CD-ROM, a flexible disk (FD), a CD-R, and a DVD (Digital Versatile Disk) as files of an installable format or executable format and may be provided.

The OS and the computer programs executed by the POS terminal control device 100 according to this embodiment may be provided or distributed by storing them in a computer connected to a network such as the Internet or a LAN and downloading them via the network.

The controller 300 of the POS terminal control device 100 according to this embodiment includes a registering unit 301, a reservation unit 302 (an overall POS reserved registering information updating section 302a, an overall POS reserved registering information notifying section 302b, and a reservation sheet issuing section 302c), an overall POS reserved registering information list display unit 303, and a restarting unit 304 as shown in FIG. 3. Actually, regarding the hardware, the CPU 201 reads the control programs from the HDD 207 and loads it into the RAM 204, whereby the CPU 201, the ROM 203, and the RAM 204 constitute the controller 300 including the registering unit 301, the reservation unit 302 (the overall POS reserved registering information updating section 302a, the overall POS reserved registering information notifying section 302b, and the reservation sheet issuing section 302c), the overall POS reserved registering information list display unit 303, and the restarting unit 304.

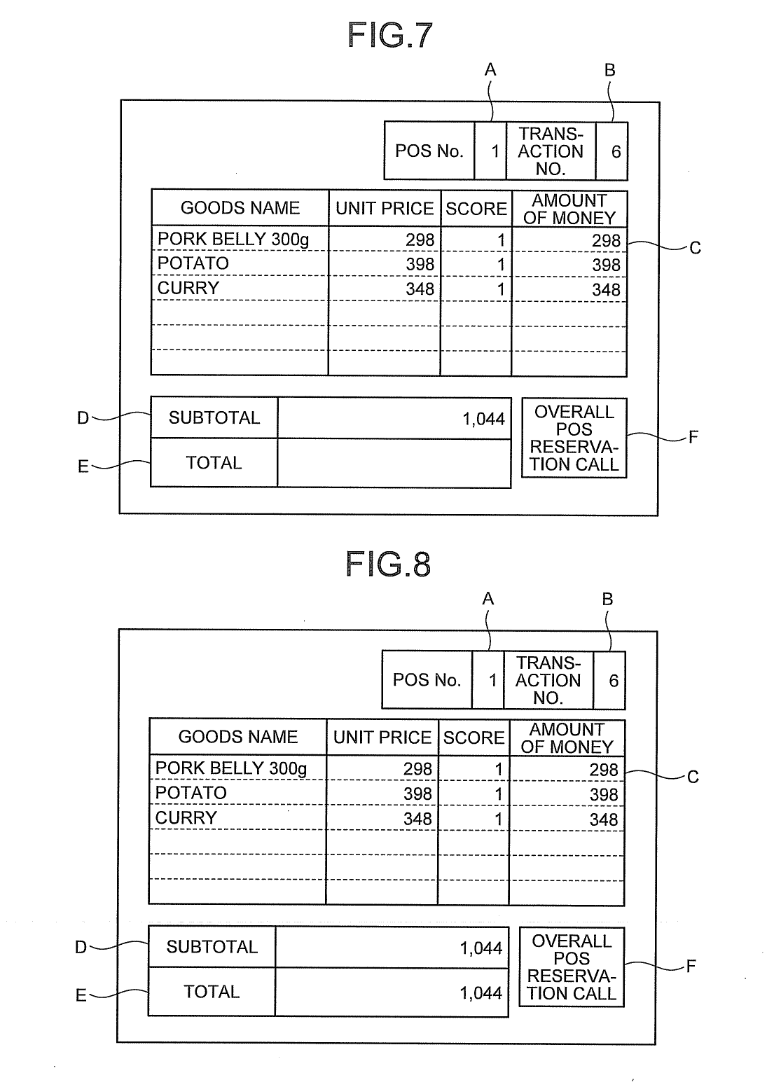

The registering unit 301 performs a process of registering goods to be transacted with a customer. Specifically, a sale registering picture (hereinafter, also referred to as a “registering picture”) is displayed on the information display device 102 shown in FIG. 7 and goods information such as goods names, unit prices, scores, and amounts of money of goods are stored in the RAM 204 as a buffer memory with POS Nos. and transaction numbers given thereto. At this time, the registering information stored in the RAM 204 is temporarily stored until the deadline. When the deadline is reached, the registering information is added to and stored in a transaction history stored in the data storage device 103 of the POS terminal control device 100. When a reservation key of the keyboard of the input device 101 is pressed, a reservation process is performed (reservation date and time are given thereto) by the reservation unit 302 to be described below and then a next customer sale registering picture is displayed.

Here, the registering picture will be roughly described with reference to FIG. 7. In the registering picture, a POS No. indicated by reference sign A and allocated to the POS terminal control device 100, a transaction No. indicated by reference sign B and allocated to each transaction, a list of sold goods information (only goods names, unit prices, scores, and amounts of money of goods are displayed in the example shown in FIG. 7) indicated by reference sign C, a subtotal of amounts of money of input goods indicated by reference sign D, a total indicated by reference sign E in which the total amount of money is displayed at the time of totaling deadline, and an overall POS reserved call button (to be described in detail later) indicated by reference sign F are displayed. FIG. 7 shows a simplified example for the purpose of simple explanation.

The reservation unit 302 reserves the sale registering process being performed by the registering unit 301 when the reservation key of the keyboard disposed in the input device 101 is pressed. The reservation unit 302 includes an overall POS reserved registering information updating section 302a, and overall POS reserved registering information notifying section 302b, and a reservation sheet issuing section 302c.

The overall POS reserved registering information updating section 302a stores and updates information on a transaction to be reserved in an overall POS reserved sale registering information table of the data storage device 103. FIG. 4 shows an example of the overall POS reserved sale registering information table stored in the data storage device 103. As shown in the drawing, the overall POS reserved sale registering information table stores the POS no. the transaction No. (transaction number), the reservation date and time, and a status (in reservation or in registration) as information on a transaction to be reserved and as a transaction record. The overall POS reserved registering information updating section 302a stores the goods information stored in the RAM 204 in the data storage device 103 in correlation with the record in the overall POS reserved sale registering information table based on the POS No. and the transaction No. when the registering process is reserved. When the overall POS reserved sale registering information table and the overall sale registering information to be reserved are notified from another POS terminal control device 100, the information is shared by all the POS terminal control devices 100 and thus the overall POS reserved sale registering information table and the overall sale registering information to be reserved of the POS terminal control device 100 notified are updated. The overall POS reserved sale registering information table and the overall sale registering information to be reserved shared by all the POS terminal control devices 100 are information used to restart the sale registering process to be reserved (reserved registering information).

The overall POS reserved registering information notifying section 302b notifies another POS terminal control device 100 of the overall POS reserved sale registering information table and the overall sale registering information to be reserved (at the time of reservation) which are updated by the overall POS reserved registering information updating section 302a. The overall POS reserved registering information updating section 302a in the notified POS terminal control device 100 updates the overall POS reserved sale registering information table and the overall sale registering information to be reserved. When the restarting process is finished, the overall POS reserved registering information notifying section 302b notifies another POS terminal control device 100 of the overall POS reserved sale registering information table from which the record having been subjected to the sale registering process is deleted and updated by the overall POS reserved registering information updating section 302a. The information notified to another POS terminal control device 100 by the overall POS reserved registering information notifying section 302b may be only the difference before and after the updating. In this case, the notified POS terminal control device 100 updates the overall POS reserved sale registering information table and the overall sale registering information to be reserved of the POS terminal control device 100 itself on the basis of the notified information.

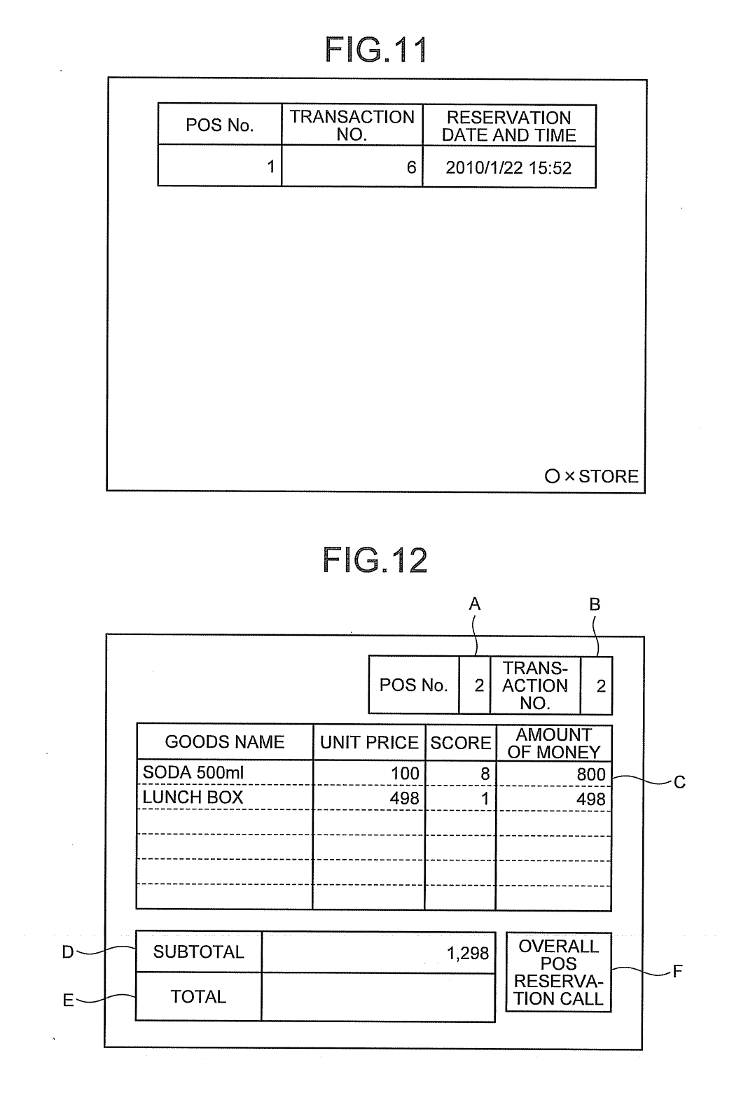

The reservation sheet issuing section 302c causes the printing device 104 to issue a sheet (hereinafter, referred to as a reservation sheet) on which information for specifying the sale registering information to be reserved is described as shown in FIG. 11. In the example shown in FIG. 11, the POS No. (1), the transaction No. (6), and the reservation date and time (2010/1/22, 15:52) are printed as the information for specifying the sale registering information to be reserved.

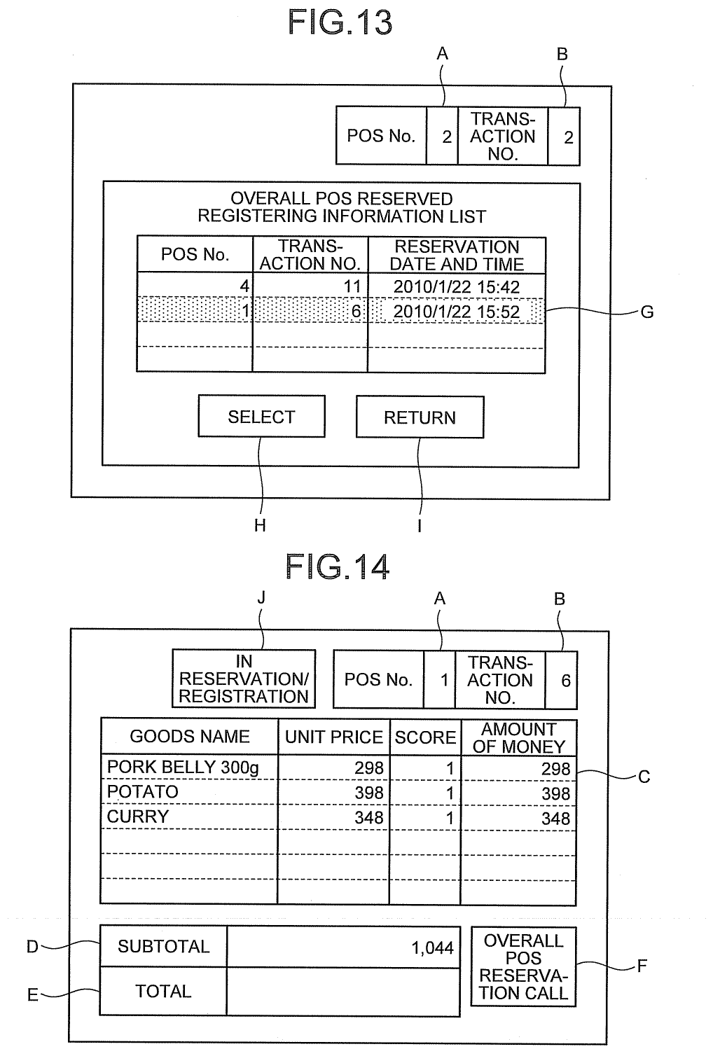

The overall POS reserved registering information list display unit 303 displays an overall POS reserved registering information list (reference sign G in FIG. 13) on the information display device 102 when the overall POS reservation call button F (see FIG. 7) or an exclusive key displayed on the information display device 102 is pressed. Reserved information corresponding to a record of which the status in the overall POS reserved sale registering information table is not “in reservation” but “in registration” is not displayed because a certain POS terminal control device 100 performs the sale registering process on the reserved object.

Regarding the overall POS reserved registering information list displayed by the overall POS reserved registering information list display unit 303, when a cashier selects a record (reservation information) displayed in the overall POS reserved registering information list on the basis of the reservation sheet carried by a customer, the restarting unit 304 releases the reservation of the reserved registering information and restarts the goods registering process. With the restarting of the registering process, the status of the corresponding (selected) record in the overall POS reserved sale registering information table is changed from “in reservation” to “in registration”.

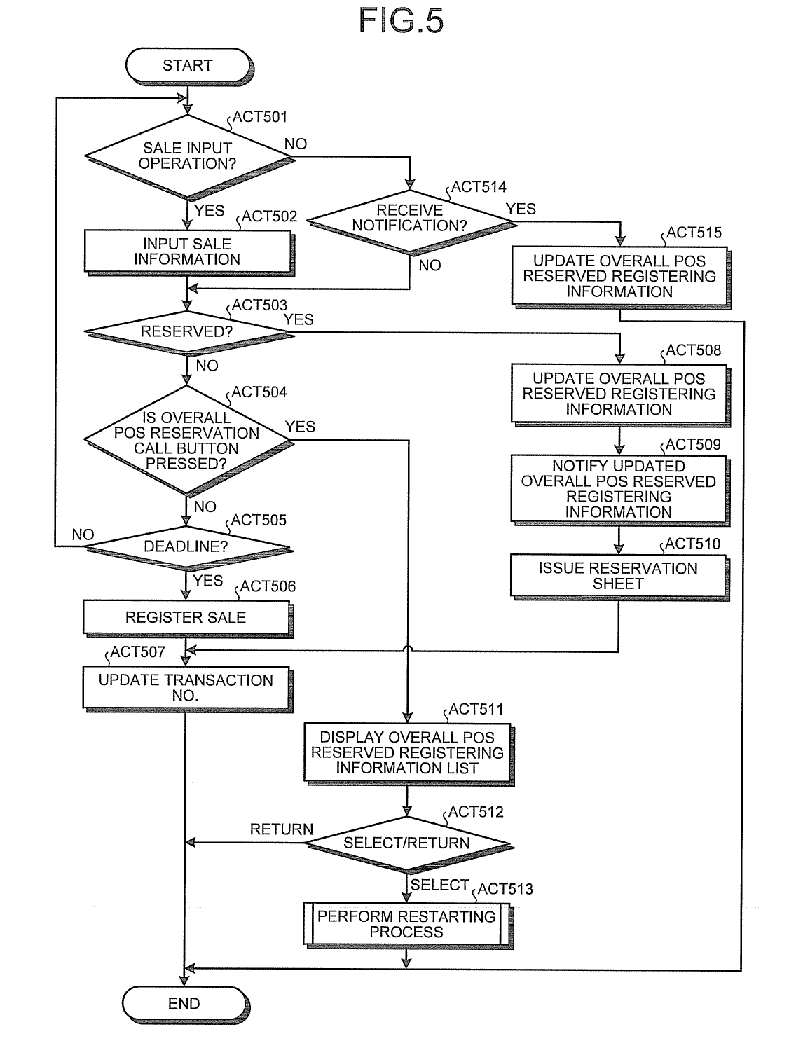

The flow of the goods registering process including a reservation process will be described below with reference to FIG. 5. FIG. 5 is a flow diagram illustrating the flow of the goods registering process including the reservation process. The goods registering process including the reservation process from start to end shown in the flow diagram of FIG. 5 is repeatedly performed while the POS terminal control device 100 is activated.

First, it is determined whether a cashier performs a goods sale input operation using the input device 101, and the sale information input by sold goods is stored as the sale registering information in the RAM 204 as the buffer memory (inputting of sale information: Act 502) when the sale input operation is performed (YES in Act 501). At this time, a registering picture of which an example is shown in FIG. 7 is displayed on the information display device 102.

Here, the flow diagram of FIG. 5 is referred to again. After Act 502 or when the determination result in Act 501 is NO, it is determined whether the reservation key is pressed (Act 503). When the reservation key is not pressed (NO in Act 503), it is determined whether the overall POS reservation call button F is pressed (Act 504). When the overall POS reservation call button F is not pressed (NO in Act 504), it is determined whether the total and the deadline are reached (Act 505).

At this time, when the total and the deadline are not reached (NO in Act 505), the process of Act 501 is performed again. On the other hand, when the total and the deadline are reached (YES in Act 505), the sale registering process is performed on the input sale registering information (Act 506). Specifically, the sale registering information of the current transaction is added to the transaction history stored in the data storage device 103 and the sale registering information temporarily stored in the RAM 204 as the buffer memory is deleted. At the time of total and deadline, the registering picture displayed on the information display device 102 is as shown in FIG. 8. Regarding the goods information currently input, the total amount of money is displayed in the total indicated by reference sign E.

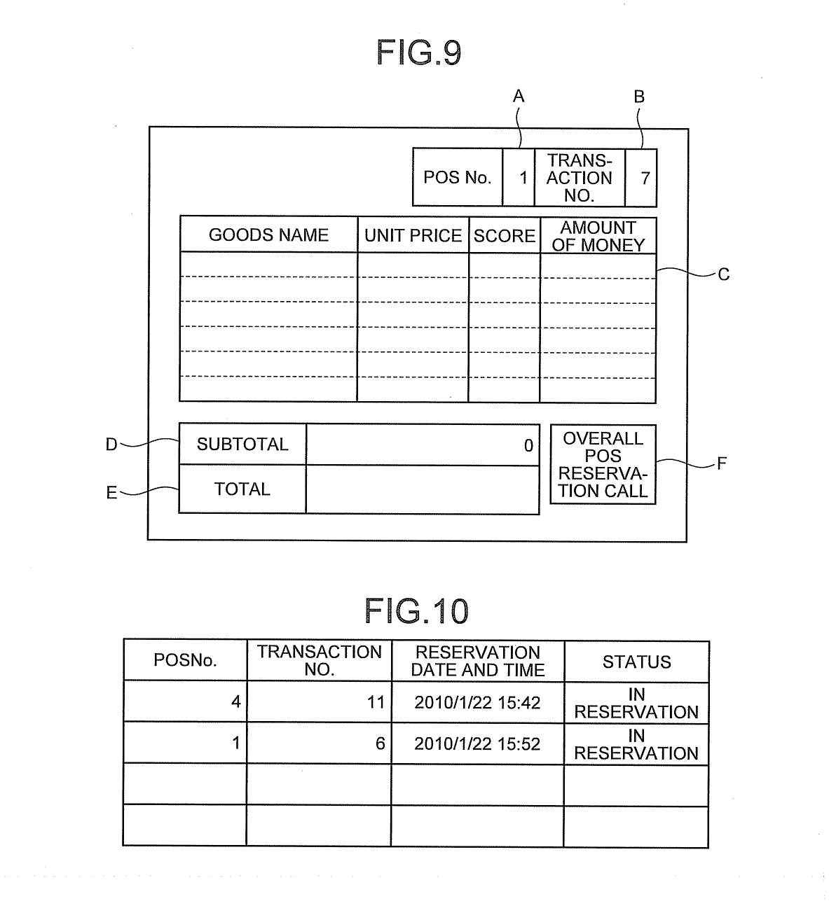

In order to register the sold goods of a next customer, the transaction No. is updated (Act 507). At this time, the registering picture displayed on the information display device 102 is as shown in FIG. 9. The transaction No. indicated by reference sign B is updated from “6” to “7”, and the goods information list indicated by reference sign C, the subtotal indicated by reference sign D, and the total indicated by reference sign E are cleared.

On the other hand, when the reservation key is pressed in the course of registering sold goods, the determination result in Act 503 is YES and the process of Act 508 is performed. In Act 508, the overall POS reserved registering information updating section 302a performs the overall POS reserved registering information updating process. Specifically, the information on the reservation target is stored and updated in the overall POS reserved sale registering information table of the data storage device 103. For example, when the overall POS reserved sale registering information table shown in FIG. 4 is updated, the reservation information (POS No.: 1, transaction No.: 6, reservation date and time: 2010/1/22 15:52, status: in reservation) of this reserved transaction is added thereto as shown in FIG. 10. The overall POS reserved registering information updating section 302a stores the sale registering information (POS No., transaction number given to each registering process, reservation date and time, and goods information (goods name, unit price, score, amount of money, and JAN code) stored in the RAM 204 when the registering process is reserved) to be reserved (not shown) in the data storage device 103 in correlation with the corresponding record in the overall POS reserved sale registering information table based on the POS No. and the transaction No.

The overall POS reserved information notifying section 302b notifies another POS terminal control device 100 of the updated overall POS reserved sale registering information table and the overall sale registering information to be reserved (Act 509). Another POS terminal control device 100 receiving this notification (YES in Act 514) updates the overall POS reserved sale registering information table and the overall sale registering information to be reserved stored in its own data storage device 103 (Act 515). In Act 509, as described above, only the difference before and after the updating may be notified to another POS terminal control device 100.

The reservation sheet issuing section 302c issues a reservation sheet (Act 510). At this time, a cashier causes the printing device 104 to print out the reservation sheet in which information for specifying the sale registering information to be reserved shown in FIG. 11 is mentioned and hands over the reservation sheet to a customer. The controller 300 performs the process of Act 507 after ending the flow of the reservation process. In Act 507, as described above, the transaction No. is updated by the registering unit 301 and a registering picture for registering sold goods of a next customer is displayed.

On the other hand, when the overall POS reservation call button F is pressed in a certain POS terminal control device 100, the determination result in Act 504 is YES and the process of Act 511 is performed. The process flow shown in the flow diagram of FIG. 5 is performed by all the POS terminal control devices 100 and the same process flow is performed when the overall POS reservation call button F is pressed in any POS terminal control device 100.

In Act 511, the overall POS reserved registering information list is displayed on the information display device 102 by the overall POS reserved registering information list display unit 303. For example, when the overall POS reservation call button F is pressed in the registering picture shown in FIG. 12 in the POS terminal control device 100 of POS No. 2, the overall POS reserved registering information list indicated by reference sign G in FIG. 13 is displayed. The details correspond to those shown in FIG. 10. At this time, when the “return” button indicated by reference sign I is pressed, the flow shown in the flow diagram of FIG. 5 is ended depending on the determination result in Act 512. However, since the processes from start to end are repeatedly performed, the sale registering process is restarted in the previous registering picture (see FIG. 12). On the other hand, when a record of POS No. 1 and transaction No. 6 (the hatching portion) is designated with the POS No. and the transaction No. of the reservation sheet presented by a customer and the “select” button indicated by reference sign H is pressed, the process of Act 513 is performed depending on the determination result of Act 512 and the restarting process to be described later is started.

When the restarting process of Act 513 is ended, or when the transaction No. updating process of Act 507, or when the “return” button is pressed in Act 512, the process flow is ended. Thereafter, the flow of the sale registering process of Acts 501 to 513 is repeatedly performed.

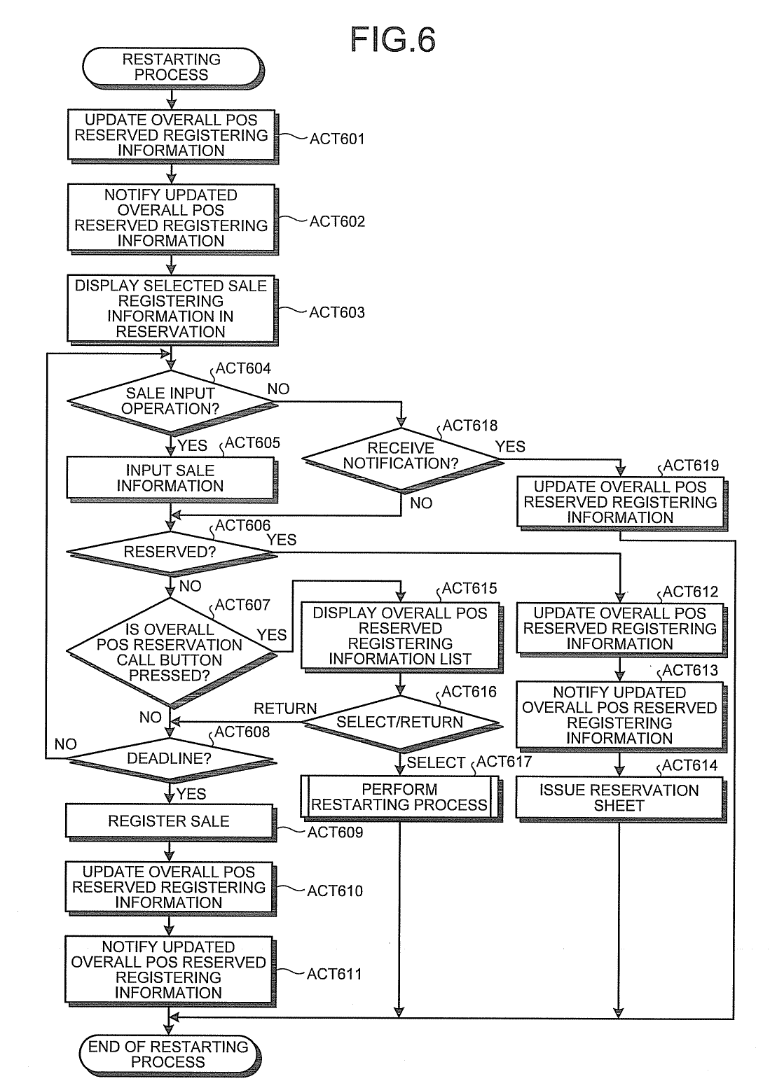

The restarting process of Act 513 will be described below with reference to FIG. 6. FIG. 6 is a flow diagram illustrating the flow of the restarting process.

First, in the POS terminal control device 100 of which the overall POS reservation call button F is pressed, the overall POS reserved registering information updating section 302a performs the overall POS reserved registering information updating process (Act 601). Here, since the restarting process is performed, the status of the corresponding record in the overall POS reserved sale registering information table is updated to “in registration”.

The overall POS reserved registering information notifying section 302b notifies another POS terminal control device 100 of the updated overall POS reserved sale registering information table and the overall sale registering information to be reserved as described above (Act 602). Another POS terminal control device 100 receiving this notification updates the overall POS reserved sale registering information table and the overall sale registering information to be reserved stored in its own data storage device 103. In this notification, as described above, only the difference before and after the updating may be notified.

The selected sale registering information in reservation is displayed (Act 603). For example, when the record of POS NO. 1 and transaction No. 6 is designated in the display picture of the overall POS reserved registering information list in the POS terminal control device 100 of POS No. 2 indicated by reference sign G in FIG. 13 and is selected by pressing the “select” button indicated by reference sign H, the POS terminal control device 100 of POS No. 2 displays the registering picture shown in FIG. 14. The registering picture is the same as the registering picture just before the reservation in the POS terminal control device 100 of POS No. 1 shown in FIG. 7, except for the mark of “in reservation and registration” indicated by reference sign J.

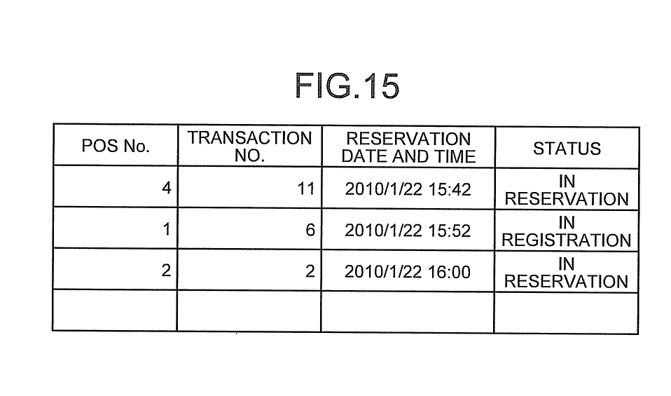

Just before the restarting process, the POS terminal control device 100 of POS No. 2 performs the reservation process while performing the sale registering process shown in FIG. 12, the sale registering information in the POS terminal control device 100 of POS No. 2 is added to the overall POS reserved sale registering information table and the status is updated to the “in reservation”, as shown in FIG. 15, by means of the overall POS reserved registering information updating process and the updated overall POS reserved information notifying process. The status of the record of POS No. 1 and transaction No. 6 being subjected to the sale registering process or restarted is changed to “in registration” by means of the overall POS reserved registering information updating process of Act 601.

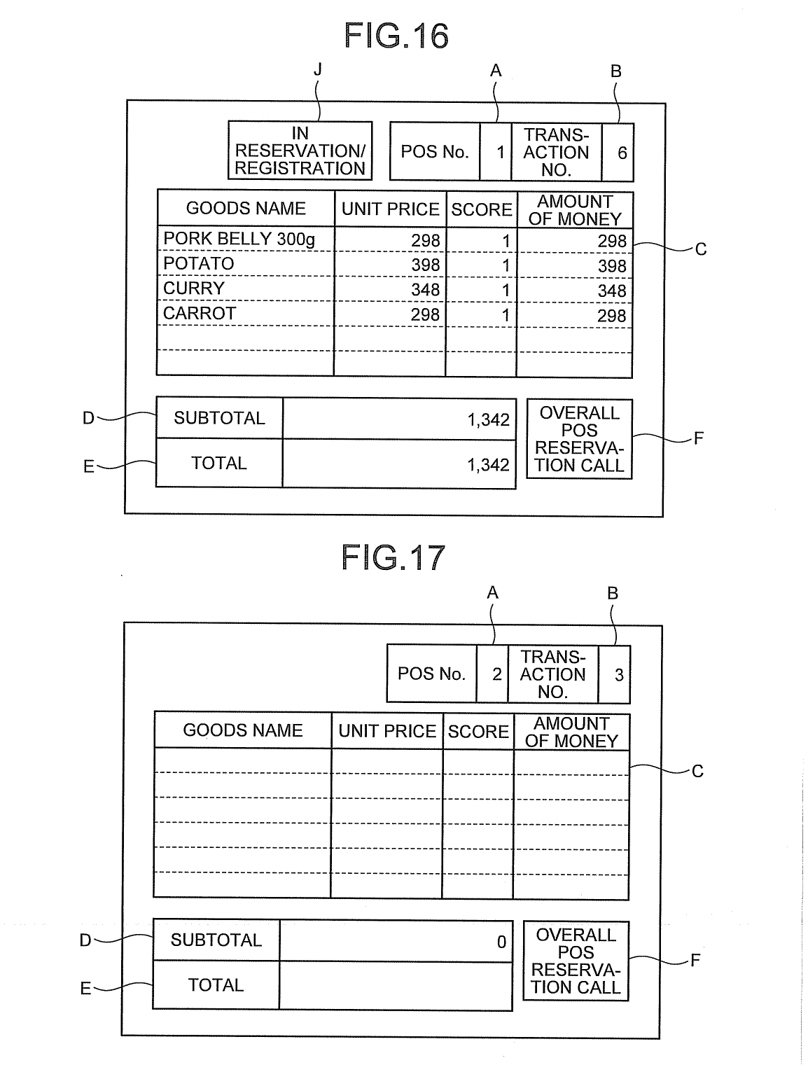

The subsequent processes of Acts 604 to 609 are the same as the processes of Acts 501 to 506, the processes of Acts 615 to 617 are the same as the processes of Acts 511 to 513, the processes of Acts 612 to 614 are the same as the processes of Acts 508 to 510, the processes of Acts 618 to 619 are the same as the processes of Acts 514 to 515, and thus the detailed description thereof is not made. When the additional input and the total and deadline are reached in the processes of Acts 604 to 609 during the restarting process, the registering picture of the POS terminal control device 100 of POS No. 2 is changed from the registering picture shown in FIG. 14 to the registering picture shown in FIG. 16 including the additional data and the updated subtotal and total. When the restarting process is ended, a new registering picture in which the transaction No. is updated and which is shown in FIG. 17 is displayed.

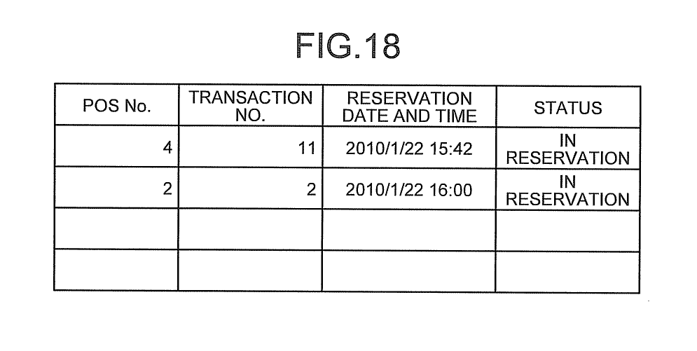

In Act 610, as the overall POS reserved registering information updating process, the overall POS reserved registering information updating section 302a performs a process of deleting the record corresponding to the POS No. and the transaction No. registered in the restarting process from the overall POS reserved sale registering information table (for example, the overall POS reserved sale registering information table shown in FIG. 15 is changed to the table shown in FIG. 18 in which the corresponding record is deleted therefrom) and deleting the sale registering information corresponding to the record is performed.

In Act 611, the overall POS reserved registering information notifying section 302b notifies another POS terminal control device 100 of the updated overall POS reserved sale registering information table which is subjected to the sale registering process and from which the corresponding record is deleted by the overall POS reserved registering information updating section 302a. Another POS terminal control device 100 receiving this notification updates the overall POS reserved sale registering information table and deletes the sale registering information corresponding to the record subjected to the sale registering process. The POS terminal control device 100 as a reservation source receiving the notification deletes the sale registering information stored in the RAM 204 as the buffer memory. The registered sale registering information is stored in the transaction history of the POS terminal control device 100 restarting the sale registering process and finishing the process.

The configurations and the registering pictures described above and the specific details shown in the flow diagrams of FIGS. 5 and 6 are only exemplary and can be appropriately modified.

As described above, in the goods sale data processing system according to this embodiment, it is possible to allow any POS terminal control device 100 to restart the sale registering process reserved by another POS terminal control device 100, that is, to reserve the goods registration of plural customers. Since the above-mentioned overall POS reserved sale registering information table and the sale registering information necessary for the sale registering process are shared by plural POS terminal control devices 100, it is possible to obtain resistance to a trouble such as disorder at the time of reservation.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A goods sale data processor comprising:
registering unit for performing a process of registering goods to be transacted;
storage unit for storing reserved registering information to be reserved;
reserved registering information updating unit for updating and storing the reserved registering information to be reserved in the storage unit when the registering process is reserved, the registering process is being performed by the registering unit, and when the updated reserved registering information is notified from another goods sale data processor;
reserved registering information notifying unit for notifying another goods sale data processor of the reserved registering information updated by the reserved registering information updating unit when the processor reserves the registering process; and
restarting unit for receiving the selection of the reserved registering information used to restart the registering process out of the reserved registering information stored in the storage unit and restarting the registering process using the selected reserved registering information when the registering process is requested to restart.

2. The goods sale data processing processor according to claim 1, further comprising display unit for displaying a list corresponding to the overall reserved registering information stored in the storage unit and receiving the selection of a target,
wherein the restarting unit receives the selection via the display unit.

3. The goods sale data processing processor according to claim 1, further comprising issuing unit for issuing a sheet for identifying the reserved registering information used to restart the registering process to be reserved when the registering process is reserved, the registering process is being performed by the registering unit.

4. A control method of a goods sale data processor, comprising:
performing a process of registering goods to be transacted;
storing reserved registering information to be reserved in a storage unit;
updating and storing the reserved registering information to be reserved in the storage unit when the registering process is reserved, the registering process is being performed in the registering, and when the updated reserved registering information is notified from another goods sale data processor;
notifying another goods sale data processor of the reserved registering information updated in the updating when the processor reserves the registering process; and
receiving the selection of the reserved registering information used to restart the registering process out of the reserved registering information stored in the storage unit and restarting the registering process using the selected reserved registering information when the registering process is requested to restart.

5. The method according to claim 4, further comprising displaying a list corresponding to the overall reserved registering information stored in the storage unit on a displaying unit and receiving the selection of a target,
wherein the selection is received via the display unit in the restarting.

6. The method according to claim 4, further comprising issuing a sheet for identifying the reserved registering information used to restart the registering process to be reserved when the registering process is reserved, the registering process is being performed in the registering.
